(19) United States
(12) Patent Application Publication
(10) Pub. No.: US 2024/0001650 A1
(43) Pub. Date: Jan. 4, 2024

(54) SEAL

(71) Applicant: SGL CARBON SE, Wiesbaden (DE)

(72) Inventors: Thomas KIRSCHBAUM, Meitingen (DE); Thomas KOECK, Meitingen (DE); Werner LANGER, Meitingen (DE); Juergen BACHER, Meitingen (DE); Lea SCHUMANN, Meitingen (DE); Christina LOEFFLAD, Meitingen (DE)

(73) Assignee: SGL CARBON SE, Wiesbaden (DE)

(21) Appl. No.: 18/252,564

(22) PCT Filed: Nov. 15, 2021
(86) PCT No.: PCT/EP2021/081668

§ 371 Date: May 11, 2023

(30) Foreign Application Priority Data
Nov. 17, 2020 (DE) 10 2020 214 437.0

(51) Int. Cl. B32B 18/00; B32B 33/00; B32B 37/10

(52) U.S. Cl. CPC B32B 18/00; B32B 33/00; B32B 37/10; B32B 2309/105; B32B 2313/04

(57) ABSTRACT

A seal for flange connections, as well as to the production of the seal and its use.

### FIELD

The present invention relates to a seal for flange connections, as well as to the production of the seal and its use.

### BACKGROUND

The use of seals made of graphite foil or layered composite materials containing graphite foil, e.g., in pipelines and apparatuses in the chemical industry and steam lines in power plants and in heating systems, is prior art. Graphite foil is produced by thermal expansion of a graphite intercalation compound and subsequent compression of the accordion-like particles obtained by the expansion. These particles are interlocked during compression under pressure such that stable, flexible flat structures like foils or sheets can be produced therefrom without the addition of binders. Graphite foil is characterized by resistance to high temperatures and aggressive media, relatively low permeability to fluids, high compressibility, good resilience, and a very low tendency to creep under pressure. These properties establish the suitability of graphite foil as a sealing material.

The mechanical stability of seals made of graphite can be increased by embedding reinforcing inserts made of metal (sheet metal or foil) between two graphite foils. Therefore, for seals according to the prior art with a total thickness of 1 to 4 mm, layered composite materials of several graphite foils only a few hundred strong, between which metal inserts are embedded, are usually used.

A method for producing layered composite materials from several alternating metal and graphite layers is known from the European patent EP 0 616 884. Between the metal and the graphite layers, a non-detachable, adhesive-free composite is produced by applying a surface-active substance from the group of organosilicon compounds, perfluorinated compounds, or metal soaps in a thin layer to at least one of the surfaces to be bonded, and then bringing the surfaces to be bonded into contact and bonding them to one another by exposure to pressure and heat.

A disadvantage of the seals described in the prior art is the adhesive effect of the seals during use in, for example, flanges, so that they can be replaced only with difficulty.

### SUMMARY

The object of the present invention is to provide a seal which is non-adhesive during application, as well as a method for producing the non-adhesive seal.

This object is achieved by a seal for flange connections, comprising a layer of impregnated and coated graphite foil or a composite of at least two layers of graphite foil, wherein a reinforcement is applied between each two layers of graphite foil, and the outer surfaces of the composite have an impregnation and a coating.

In an advantageous embodiment, the graphite foil comprises expanded graphite. To produce graphite foils, expanded graphite must first be produced with a worm-shaped structure; to do this, graphite such as natural graphite is typically mixed with an intercalate such as, for example, nitric acid or sulfuric acid, and heat-treated at an elevated temperature of, for example, 600° C. to 1,200° C. (DE10003927A1)

Expanded graphite constitutes a graphite which, in comparison to natural graphite, is for example expanded by a factor of 80 or more in the plane perpendicular to the hexagonal carbon layers. Due to the expansion, expanded graphite is characterized by excellent formability and good cutting ability. The expanded graphite can be pressed into the form of a foil by means of pressure.

Graphite foils have a high resistance to temperature and media.

According to the invention, the impregnation is selected from the group of paraffins, long-chain hydrocarbons, or mixtures thereof—preferably Vaseline. Vaseline is preferred since it has the property of not sticking much, but does not prevent adhesive bonding. In the context of this invention, long-chain hydrocarbons are, for example, understood to be alkanes having the general molecular formula CₙH₂ₙ₊₂, wherein the number n is between 18 and 32, and the molar mass is therefore between 275 and 600 grams per mole.

According to the invention, the coating is selected from the group of fat soaps, mica, graphite powder, talcum, or mixtures thereof—preferably fatty soaps.

In the context of this invention, fatty soaps are understood to mean sodium or potassium salts of the fatty acids, but also fatty acids of the metals Li, Ca, and Mg. Fatty acids are understood to be saturated monocarboxylic acids of the molecular formula CₙH₂ₙ₊₁COOH such as, for example, palmitic acid and stearic acid, wherein preference is given to a carbon chain length of C7-C21. Magnesium stearate is particularly preferred, since magnesium stearate is nontoxic and is a highly effective release agent. The coating prevents adhesive bonding of the seal, wherein it is applied as an active release agent without adhesive. This has the advantage that adhesive bonding in the flange is prevented due to the application without adhesive. Mixtures of fatty soaps and graphite powders are particularly advantageous, since an even higher separation effect is thereby achieved, and, moreover, a separation effect is achieved through the graphite powder even when the seal is used at high temperatures.

The reinforcement is, advantageously, a metal insert.

According to the invention, the metal insert is selected from the group of sheet metal, gasket sheet, or expanded metal.

The metal insert advantageously has a thickness of 50 μm to 150 μm.

According to the invention, the metal insert is selected from the group of stainless steel, steel, iron, aluminum, nickel, copper, titanium, or zinc, or alloys of nickel, copper, aluminum, or zinc—preferably stainless steel.

Another subject matter of the invention is a method for producing the seal, comprising the following steps:
a) providing a graphite foil,
b) providing the impregnation and the coating,
c) dispersing the coating in the impregnation,
d) applying the dispersion obtained in step c) to the outer sides of the graphite foil provided in step a),
e) storing the graphite foil from step d) for 2 h to 24 h at temperatures of 80 to 180° C., and preferably 105° C.

The graphite foil provided in step a) can be graphite foil plates or roll stock. If roll stock is used, it is cut or punched to form plates of any size, after step c).

In another advantageous embodiment, a reinforcement is additionally provided in step a), a dispersion is applied to only an outer side in step d), and step e) is followed by the steps of:
f) stacking the graphite foil obtained in step e), wherein the coating is on the respective outer side of the stack, and a reinforcement is arranged between two graphite foils,
g) pressing the stack obtained in step f) down to a thickness of 20% less.

The impregnation and coating and subsequent storage can be done both in a batch process (individual cut layers) or in a roll-to-roll process, i.e., in a continuous process. In the roll-to-roll process, the cutting to form individual cut layers is done after storage. Since the graphite foil is stored for 2 to 24 h at temperatures of 80 to 180° C., the impregnation impregnates the graphite foil and distributes it homogeneously in the graphite foil, wherein the coating remains on the surface of the graphite foil.

According to the invention, the provided impregnation in step b) is selected from the group of paraffins, long-chain hydrocarbons, or mixtures thereof—preferably Vaseline.

In a further advantageous embodiment, the provided coating is selected in step b) from the group of fatty soaps, mica, graphite powder or talcum, or mixtures thereof—preferably fatty soaps.

According to the invention, the provided layer of graphite foil or the at least two layers of graphite foil in step a) have a density of 0.7 to 1.3 g/cm³, and preferably 0.7 g/cm³. At a density greater than 1.3 g/cm³, the flexibility of the graphite foil for compensating for unevenness no longer exists. At a density of less than 0.7 g/cm³, the stability of the foil is no longer sufficient. Preference is given to a density of 0.7 g/cm³, since, with this density, the graphite foil is particularly flexible, and, during use, the foil compensates for unevenness particularly well.

According to the invention, the at least one provided reinforcement in step a) is a metal insert.

The metal insert advantageously has a thickness of 50 to 150 μm.

Use of the seal for flanges, pipe connections, in chemical plants.

### BRIEF DESCRIPTION OF THE FIGURES

The invention will be described using the following figures, without being limited thereto.

FIG. 1 shows a seal for flange connections.

FIG. 2 shows a seal for flange connections.

### DETAILED DESCRIPTION

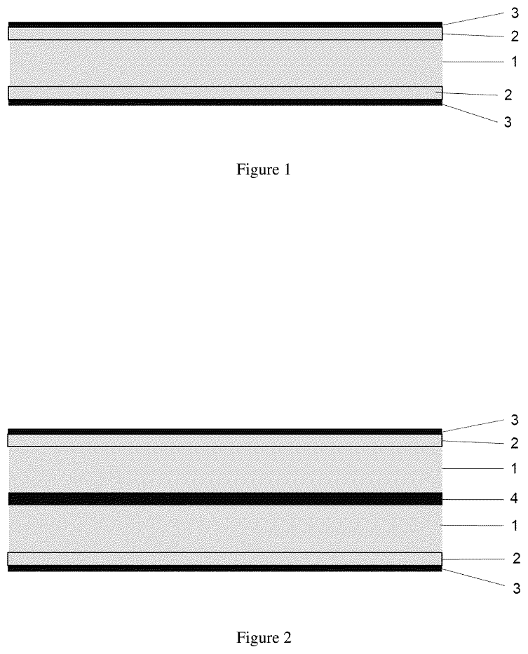

FIG. 1 shows a graphite foil (1) with an impregnation (2) and a coating (3) on both sides of the graphite foil.

FIG. 2 shows two layers of graphite foil (1), wherein a reinforcement (4) is applied between each two layers of graphite foil (1), and the outer surfaces of the composite have an impregnation (2) and a coating (3).

The present invention is explained below with reference to exemplary embodiments, wherein the exemplary embodiments do not represent a restriction of the invention.

### EXEMPLARY EMBODIMENT

Two layers of graphite foil (1,000 mm×1,000 mm) with a density of 0.7 g/cm³ are each coated on one side with a dispersion of Vaseline and magnesium stearate (2 wt % magnesium stearate in Vaseline), wherein 1 to 10 wt % Vaseline/magnesium stearate is applied to the graphite foil. This coated graphite foil is then stored at 105° C. for 24 h. Subsequently, 2 layers of coated graphite foil are stacked with a gasket sheet having a thickness of 100 μm, wherein a layer of gasket sheet is arranged between the two layers of graphite foil, and wherein the coating of the two layers of graphite foil in each case faces outwards if in each case one gasket sheet layer is arranged.

The stack of graphite foils and gasket sheet is pressed to a thickness of 2 mm.

### LIST OF REFERENCE SIGNS

(1) Graphite foil
(2) Impregnation
(3) Coating
(4) Reinforcement

1-15. (canceled)

16. A seal for flange connections, comprising: a layer of impregnated and coated graphite foil or a composite of at least two layers of graphite foil, wherein a reinforcement is applied between each two layers of graphite foil, and the outer surfaces of the composite have an impregnation and a coating.

17. The seal according to claim 16, wherein the graphite foil comprises expanded graphite.

18. The seal according to claim 16, wherein the impregnation is selected from the group of paraffins, long-chain hydrocarbons, or mixtures thereof.

19. The seal according to claim 16, wherein the coating is selected from the group of fatty soaps, mica, graphite powder or talcum, or mixtures thereof.

20. The seal according to claim 16, wherein the reinforcement is a metal insert.

21. The seal according to claim 20, wherein the metal insert is selected from the group of sheet metal, gasket sheet, or expanded metal.

22. The seal according to claim 20, wherein the thickness of the metal inserts is 50 μm to 150 μm.

23. The seal according to claim 20, wherein the metal insert is selected from the group of stainless steel, steel, iron, aluminum, nickel, copper, titanium, or zinc, or alloys of nickel, copper, aluminum, or zinc.

24. A method for manufacturing the seal according to claim 16, comprising the following steps:
a) providing a graphite foil,
b) providing the impregnation and the coating,
c) dispersing the coating in the impregnation,
d) applying the dispersion obtained in step c) to the outer sides of the graphite foil provided in step a),
e) storing the graphite foil of step d) for 2 h to 24 h at temperatures of 80 to 180° C.

25. The method according to claim 24, wherein a reinforcement is additionally provided in step a), and only one outer side is coated in step d), and step e) is followed by the steps of:
f) stacking the graphite foil obtained in step e), wherein the coating is on the respective outer side of the stack, and a reinforcement is arranged between two graphite foils,
g) pressing the stack obtained in step f) down to a thickness of 20% less.

26. The method according to claim 24, wherein the provided impregnation in step b) is selected from the group of paraffins, long-chain hydrocarbons, or mixtures thereof.

27. The method according to claim 24, wherein the provided coating in step b) is selected from the group of fatty soaps, mica, graphite powder or talcum, or mixtures thereof.

28. The method according to claim 24, wherein the provided graphite foil in step a) has a density of 0.7 to 1.3 g/cm³.

29. The method according to claim 25, wherein the provided reinforcement in step a) is a metal insert.
